(19) United States
(12) Patent Application Publication
(10) Pub. No.: US 2015/0177979 A1
(43) Pub. Date: Jun. 25, 2015

(54) METHOD OF CONTROLLING A GRAPHICAL USER INTERFACE FOR A MOBILE ELECTRONIC DEVICE

(71) Applicants: Magnus Johansson, Dosjebro (SE); Petter Alexandersson, Bjarred (SE)

(72) Inventors: Magnus Johansson, Dosjebro (SE); Petter Alexandersson, Bjarred (SE)

(73) Assignee: SONY CORPORATION, Tokyo (JP)

(21) Appl. No.: 14/576,455

(22) Filed: Dec. 19, 2014

Related U.S. Application Data
(63) Continuation-in-part of application No. PCT/IB2013/061167, filed on Dec. 20, 2013.

(51) Int. Cl. G06F 3/0488; G06F 3/041; G06F 3/0484

(52) U.S. Cl. CPC G06F 3/04883; G06F 3/04845; G06F 3/0412; G06F 3/0416; G06F 2203/04104; G06F 2203/041; G06F 2203/04808

(57) ABSTRACT

The present invention concerns a method of controlling a layout of media items on a user interface of a touch sensitive display. The invention also concerns a mobile electronic communication device using the method.

### CROSS REFERENCE TO RELATED APPLICATION

This application is a continuation-in-part of International Application No. PCT/IB2013/061167, filed Dec. 20, 2013, the disclosure of which is hereby incorporated herein by reference.

### TECHNICAL FIELD

The present invention relates to a method of controlling a graphical user interface of a mobile electronic device, and a mobile electronic device using the method for controlling its graphical user interface.

### BACKGROUND ART

The use of electronic devices such as computers, mobile phones, and audio/video equipment has had enormous development in the world in the last decades. A lot of effort has been made in making smaller electronic devices, in particular for portable use, such as mobile phones, laptop computers, Personal Digital Assistants (PDA), and so on. Much help has been obtained from miniaturization of electronic components and development of more efficient batteries. Mobile phones are getting smaller and smaller and the size is generally considered to be an important factor for the end customer, as well as the need for simplifying the handling of the applications in mobile phones by making the applications more intuitively handled.

Regarding mobile devices, the end users have a number of conflicting requirements. Basically, devices should be as small and light-weight as possible, while providing more and more advanced functions, and having a user-friendly interface. There is also only so much space in an electronic device, and in order to be competitive the elements of devices must be carefully packaged. The compact size of e.g. mobile phones also means that the user interface, typically a display, is limited. However, recently, so called smart phones have been provided with larger displays in new models compared to the former ones. In order to access different functions and stored items, different types of menu systems are employed in combination with touch sensitive displays with more and more use of icons representing, e.g. a set of data, a program, media files, e.g. music or video files, pictures/images, or an action, in mobile phones. A graphical user interface (GUI) is often configured with a plurality of icons on a display, each icon representing a certain subject/item being informative and/or interactive. Clicking on one of the icons, or activation in any other way of the icon, using the user input interface of the portable electronic device typically results in the presentation of a menu associated with the subject of the icon/item.

A problem related to the issue of generating GUI layouts for electronic devices, particularly portable devices such as mobile phones, is that the devices generally make use of one or more generic and fixed layouts for use in different themes. The layouts are typically hard coded into the software residing in the devices, and cannot be changed in an easy way. Furthermore, the layouts are often quite complex and a lot of work is generally required from both design engineers and software engineers before a final product is obtained. Today, one method used is to have design engineers create GUI layout documents, including sketches of the layouts with different associated measurements, such as offsets, heights and widths of objects and so on. This work is both cumbersome and time-consuming.

Another problem concerns that modern-day handheld communication devices, such as mobile phones, are capable of performing a multitude of tasks ranging from voice communication to sending e-mails, editing and sharing documents, browsing the Internet, playing music and movie files, etc. However, due to the form factor of modern mobile communication devices many of these tasks are difficult to perform in parallel due to huge amounts of information presented on a restricted available area on touch sensitive displays of such devices. This compromise between a lot of information and a large number of icons on relatively small display areas is difficult to optimize as also the touch sensitive resolution of the touch sensitive display areas comprises a grid of a certain mesh that may not be too fine to create too many errors of detection when touching certain portions of the touch sensitive areas of the displays with a finger or stylus, e.g. by missing the desired area or touching a too large area. Furthermore, the amount of functionalities expected to be performed by the user interface is steadily increasing which results in greater complexity for the user. The tedious navigation and operation of such devices may result in that users will be “lost” in different menus that do not appeal to them and/or menus that are too “rigidly” designed. This often also requires small fingers and a steady hand for any user of handheld electronic devices for not resulting in unnecessary and troublesome remake of faulty or undetected inputs and unsatisfactory long waiting time for the user.

### SUMMARY OF THE INVENTION

With the above description in mind, then, an aspect of the present invention is to provide a method for control of a layout of media items and their media fields on an user interface for a mobile electronic device comprising a touch sensitive display, which seek to mitigate, alleviate, or eliminate one or more of the above-identified deficiencies in the art and dis-advantages singly or in any combination. Hence, as the technological development has led to increased touch screen touch resolution and increased pixel density, there is a need for easy rearranging but also adaptation of the touch areas of interactive items on the screen, i.e. a display of a mobile electronic device to ensure that a user is able to see, identify and touch a desired item, which the user wants to view, e.g. to see a picture in more or less detail, and/or interactively use, for example if the item is a music and/or video file that the user wants to listen to and/or watch and/or just wants to know more or less about the music/video file. The compromise between a large display, e.g. on large a smartphone, and a practical small sized display, e.g. on a smaller smartphone, has incurred that an improved and more efficient use of available/actual/factual display area of such devices is of utmost importance.

These and further aspects are achieved by a method for controlling a layout of media items on a user interface for a mobile electronic device comprising a touch sensitive display. The method comprises detecting a dual touch action comprising two touch points; determining a distance and direction of a movement of the two touch points in relation to each other; changing the layout of the media items on the user interface in response to the determined distance and direction of the relative movement, and adapting of displayed media fields corresponding to the media items on the touch sensitive display, wherein layout/design/appearance and content of each displayed media field corresponds to the layout of the media items.

These and further aspects are achieved by a method of controlling a layout of media items on a user interface for a mobile electronic device comprising a touch sensitive display. The method comprising detecting a dual touch action comprising two touch points; determining a distance and direction of a movement of the two touch points in relation to each other; changing the layout of the media items on the user interface in response to the determined distance and direction of the relative movement, and positioning the media items with the changed layout on the user interface so that the media items with the changed layout is shown over the width of the touch sensitive display.

In accordance with one aspect of the method above, the method comprises positioning the media items with the changed layout distinctly on the user interface so that the media items with the changed layout is shown over the width and/or height of the touch sensitive display.

According to yet another aspect of the method above, the method comprises positioning the media items with the changed layout on the user interface so that an integer of media items with the changed layout is shown over the width of the touch sensitive display.

In accordance with another aspect of the method above, each media item comprises one or more media fields for displaying additional information/content of the media item.

In accordance with yet another aspect of the method above, the method comprises adapting at least one media item on the touch sensitive display by showing or hiding one or more media fields of the at least one media item corresponding to the changed layout of media items.

According to another aspect of the method above, the method comprises positioning the media items with the changed layout on the user interface so that an integer of the media items with the changed layout is shown over the height of the touch sensitive display.

In accordance with another aspect of the method above, the method comprises positioning the media items with the changed layout on the user interface so that an integer of media items with the changed layout is shown over the width and height of the touch sensitive display.

The invention optimizes/maximizes the size of layouts of media items and/or media fields on touch sensitive user interfaces in relation to the available/visual/factual area of touch sensitive displays, e.g. the width and/or the height of the display. This is done independently with respect to the display being in portrait or landscape mode. The layout is in certain cases configured to take up the whole, i.e. the full available/user accessible touch sensitive and visual width and/or height of the display.

In accordance with one aspect of the method above, comprises predetermining a grid of the media items for each layout of the media items on the user interface, whereby a grid of the layout of the media items is changed to a different grid of the layout of the media items in response to the determined distance and direction of the relative movement of the two touch points. According to another aspect of the method above, each change of layout of media items is performed by means of a distinct snap-like switch from the layout to the changed layout in response to the determined distance and direction of the relative movement of the two touch points. In yet another aspect of the method above, each change of layout of media items is performed by means of switch from the layout to the changed layout by means of the dual touch action being either a pinch gesture on the touch sensitive display decreasing the distance between the two touch points or a spread gesture on the touch sensitive display increasing the distance between the two touch points. A pinch changes to a finer grid of media items and a spread changes to a coarser grid of media items. According to still another aspect of the method above, at least one layout of the media items comprises a coarse grid for a first media item and a fine grid for one or more of the remaining media items. In another aspect, at least one of the grids comprises a coarse grid for at least one media item, e.g. a first media item, and a fine grid for the remaining media items. In accordance with an additional aspect of the method above, the number of changes of layout of the media items is controlled in response to the determined distance and direction of the relative movement of the two touch points in one and the same dual touch action. According to yet an additional aspect of the method above, the method optimizes the layout and content of each media field in relation to the size of each media item. According to a further aspect of the method above, the method optimizes the layout and content of each media field in relation to a touch resolution of the touch sensitive display. In accordance with another aspect of the method above, the method optimizes the layout and content of each media item in relation to a touch resolution of the touch sensitive display.

According to still another aspect of the method above, the amount of displayed information and/or content of the media field increases when the distance between the two touch points increases in relation to each other and the amount of displayed information and/or content of the media field decreases when the distance between the two touch points decreases in relation to each other. In one other aspect of the method above, the amount of displayed information and/or content of each media field decreases until no information and/or content of the media field is shown when the distance between the two touch points has decreased further in relation to each other. In another aspect of the method above, the amount of displayed information and/or content of each media field decreases until even no media field is visible on the media item when the distance between the two touch points has decreased further in relation to each other. According to yet another aspect of the method above, the displayed content of each media field comprises meta data and/or user selectable interactive action items, such as play or menu buttons or the like.

In accordance with additional aspects of the method above, at least one media field at least partly overlays at least one media item or at least one media field does not overlay any media item.

According to further aspects of the method above: the method increases the size of at least one media item and/or the size of at least one media field and decreases the size of at least one other media item and/or the size of at least one other media field, in the same grid of layout of media items, when changing from one media item layout to a different media item layout; the method increases the size of at least one media item and decreases the size of at least one other media item, in the same grid of layout of media items, when changing the layout of media items; the method increases the size of at least one media item and the size of at least one media field and decreases the size of at least one other media item and the size of at least one other media field, in the same grid of layout of media items, when changing the layout of media items; and the method increases the size of at least one media item or the size of at least one media field and decreases the size of at least one other media item or the size of at least one other media field, in the same grid of layout of media items, when changing the layout of media items. In one further aspect, the method positions the media items on the user interface in response to the determined distance and direction of the relative movement so that the changed layout of media items shows the media items over the height of the touch sensitive display. In another aspect, the method positions the media items on the user interface in response to the determined distance and direction of the relative movement so that the changed layout of media items shows an integer of media items over the height of the touch sensitive display. By showing an integer of media items/fields over the width and/or height of the touch sensitive display, other media items/fields are “pushed aside/away” to other visible positions on the display and/or even moved away from the visible area of the display. Hence, this means that no media items/fields are partially visible, at least not within the width of the display. In another aspect, this also enables that no media items/fields are partially visible, at least not within the height of the display.

The invention also concerns a mobile electronic communication device using the method according to any preceding aspect above for controlling its user interface on a touch sensitive display.

The inventive method and mobile electronic device for control of a Pinch-Spread Layout Grid-User Interface (PSLGUI) allows users of media applications in portable electronic devices to quickly change and to set a layout of a display that suites them in the moment, e.g. when running, at the bus, in the car, or at work. One important factor is that the amount of information and actions shown via a layout of media items/fields of a display on a portable electronic device can be made more flexible, user friendly and appealing to a larger group of users of the portable electronic device. Each media item may show more or less accessible and optional amounts of content/information and/or interactively accessible links, icons and/or symbols than hitherto. This is done in one or more media fields that are easy to change in size but also easy to reveal or hide depending on the used gesture of the user in more levels of information but also in more adaptable levels of information by using a simple and quick gesture. This is achieved due to the possibility of adapting each item, i.e. the media item and/or its media field, to the factual touch resolution of the display of the portable electronic device. This is done by making the media item and/or its media field larger for reaching over at least half or one whole touch sensitive square of the touch sensitive area of the display up to at least 4 to 5 touch sensitive square or up to all touch sensitive squares of the display if the media item and its media field covers more than one up to all touch sensitive squares of the display, e.g. along the width and/or the height of the display. The media item and/or its media field may also reach over at least one and half touch sensitive squares of the touch sensitive area of the display up to at least 4 to 5 touch sensitive squares or up to all touch sensitive squares of the display if the media item and its media field covers more than one up to all touch sensitive squares of the display, e.g. along the width and/or the height of the display. Each of the media item and/or its media field(s) may be adapted to reach over at least half the touch sensitive squares of the touch sensitive area or grid of the display when displayed in one layout of media items on a portable electronic device. Each of the media item and/or its media field(s) may be adapted to reach over at least one touch sensitive square of the touch sensitive area or grid of the display when displayed in one layout of media items on a portable electronic device. The media item and/or its media field(s) may be configured to reach over at least one touch sensitive square of the touch sensitive area or grid of the display, such that the media item and its media field(s) together reach over for example two touch sensitive squares of the touch sensitive area or grid of the display in one layout of media items on a portable electronic device. The media item or its media field(s) is for example configured to reach over at least one touch sensitive square of the touch sensitive area or grid of the display, such that the media item and its media field(s) together reach over at least one or at least one and a half or two or two and a half or three or more touch sensitive squares of the touch sensitive area or grid of the display in one layout of media items on a portable electronic device. This enables for more accurate finger and/or stylus touching of the display but also enlarges the available area of interactive and/or non-interactive data disclosed for each media item/field, while enabling easy and quick hiding of some or all the interactive and/or non-interactive data disclosed for each media item/field for a quick overview of all media items/fields. This also enables a quick and easy “jump” from one current layout of media items to another layout of media items, e.g. by switching between one lay out or lay out level at a time or by switching, i.e. in principle “jumping” past two or more layouts or lay out levels in one gesture or go. A further benefit is the quick and intuitive switching between layouts and associated touch areas of media items and media fields which is useful to a user since the demands on the touch area for the media fields and media items vary significantly depending on the situation and current/desired applications shown on the touch sensitive display. For instance if the user is exercising, it might be preferred to easily be able to change, by a single gesture, to a layout with larger touch areas for each media item and media field, i.e. to change into a more coarse grid for the layout.

The layout change affects the sizes and structure of the media items on the touch sensitive display, as well as the amount of information and actions shown on each item by means of more accessible and choosable levels of information than hitherto. The advantage is that one gesture being either a pinch or a spread may change from one level/layout of information and/or interactive media items with an overview of media items with no media fields visible or accessible to another level with the smallest media field visible with for example only one row of information in one step. In another example, this one gesture being either a pinch or a spread may change from one level/layout of information and/or interactive media items with an overview of many media items (e.g. in a 4×4 grid of media items of the same size, see FIG. 4 and corresponding FIG. 4A with this grid shown with dash-dotted lines as a grid G) with no media fields visible or accessible to another level with a small media field. Such a different lay out level is shown in FIGS. 3, 5, 5A, 6, 6A, 7, 8, 9, and 10 (e.g. in a 3×3 grid of media items of the same size or with one media item being larger, e.g. media item 11 is larger in FIGS. 5, 5A, 8, and 10 than the other media items 12-16 and FIG. 5A corresponding to FIG. 5 with a grid shown with dash-dotted lines as a grid G). Here, the media field is larger than the smallest media field times two or three or more with for example two or three or more rows of information and/or interactive links, icons and/or symbols visible on the associated media item. Another level of laid out media items 10, 11-16, X being possible to change or switch into according to the invention is shown in FIGS. 6 and 7. FIG. 6 discloses a layout of media items 11-14 of the same size in a 2×2 grid, but, here, one or more media items could be smaller or larger than the other ones, see also corresponding FIG. 6A with the touch grid shown with dash-dotted lines as a grid G. FIG. 7 discloses a layout of media items 11-12 of the same size in a 1 item row grid with a width over the whole breadth of a display, but, here, one or the other or even more media items could also be smaller or larger than the other ones, e.g. with a smaller or larger height and/or a smaller or larger width. In FIG. 7A, the media items 11, 12 are shown in a coarse layout grid compared to a fine layout grid in FIG. 7. FIG. 7A does not show any media fields 30 as in FIG. 7. In FIG. 7A, the media items 11, 12 take up the width of the display 4. The media items/fields take up the display in an integer number. In FIG. 7, the media items 11, 12 and part of media item 13 seen in the vertical direction or in the height dimension of the display 4 together with associated media fields 30 take up the width of the display 4 in an integer number. In FIG. 7A, the media items 11, 12 take up the height of the display 4 in an integer number (here, in comparison to FIG. 7, media item 13 is “pushed”/moved away “out of sight” when changing layout). In FIG. 7, the media items 11, 12 and part of media item 13 together with associated media fields 30 take up the height of the display 4. By showing media items/fields in an integer number over the width and/or height of the display 4 according to the invention, the user is provided with a clearer overview of the information/content shown on the display and the accessible factual touch sensitive and visual area of the display is efficiently used.

This touch grid of the display is referred to as the grid G in FIGS. 4A, 5A, and 6A, whereby media item 11 is the smallest (one touch square) in the largest layout of media items 11-16, X of FIG. 4A and when switching by spreading to the next layout of FIG. 5A, the first media item 11 gets bigger than the remaining ones 12-16 and media item X is hidden or “disappears”, but each media item 11-16 is now shown with a media field 30 of which media item 11 has the largest media field with somewhat more data/information/actions contained, i.e. displayed and/or accessible, than the other media fields. Hence, the now shown media fields 30 of FIG. 5A extends of more than one touch square of the grid G instead of the media items 11-16, X in FIG. 4A covering only one touch square of grid G. This is even more evident when comparing FIGS. 6 and 6A, where the media fields 30 for each media item 11 and 12 covers two touch squares of the touch grid G when switched from the layout of media items in FIGS. 5 and 5A with smaller media fields 30 and correspondingly less media field content. This is also applied to FIG. 7 where even larger media fields 30 of media items 11 and 12 are revealed after switching from the layout of FIGS. 6 and 6A to the layout of FIG. 7 by spreading gesture revealing even more content of each media field 30. Hence, when pinching, the layout may be changed back from the one in FIG. 7 to the one in FIG. 6/6A and then to the one in FIGS. 3, 5/5A, 8, 10 and then at last to the layout of FIGS. 4/4A, and 11. However, a larger distance D, D1, D2 when pinching or spreading may switch from the layout in FIG. 7 to the layouts of FIGS. 5/5A or 4/4A in one snap-like switch without passing the intermediate ones. In FIGS. 4A and 5A, the touch grid G has different sizes. The touch grid G in FIG. 5A is larger than the touch grid G in FIG. 4A. In, FIG. 5A, the touch grid G has one more row of touch squares at its upper part compared to FIG. 4A. In FIG. 7, media items 11 and 12 have the same size, while, if changing the layout to the one in FIG. 8 by pinching, i.e. decreasing the distance D between touch points I and II, media item 11 is enlarged but media item 12 is reduced in size. One example is based on the Pinch-Spread Layout Grid-User Interface (PSLGUI) of a current music album application where a grid laid-out user interface (UI) is easily changed by users in regard of media item grid size and item position by performing a pinch or spread action. Hence, this invention enables an easy rearrangement of media items for a better overview and/or a “deeper” and more detailed view of one or more media items depending on the wishes of the users.

One aspect of the inventive idea combines this PSLGUI with information and action-layering meaning that at least one media item and/or at least one media field associated with the media item is increased in size when changing from one layout to a new layout. This enlarges one or more of the media items and/or one or more media fields of the media item(s), whereby more content/information as well as more actions on the media item(s) and/or media field(s) become accessible as explained above. See examples shown in FIGS. 4A, 5A and 6A where media items 11-16 are increased in size from the layout in FIG. 4A to the layout in FIG. 5A. This optimizes the use of the available and visual touch sensitive display area by optimizing the size of each layout of media items and/or media fields in relation to physical, visual and touchable area of the display and the desire of the user. This enables optimizing the use of the available and visual touch sensitive display area by maximizing the size of any layout of media items and/or media fields by displaying them in an integer number in relation to physical, visual and touchable area of the display 4, e.g. at least along the width and/or the height of the optical display/screen 4, and the desire of the user.

Another aspect of the inventive idea combines this PSLGUI with information and action-layering meaning that at least one media item and/or at least one media field associated with the media item is decreased in size when changing from one layout to a new layout. This reduces the size of one or more of the media items and/or one or more media fields of the media item(s), whereby less content/information as well as fewer actions on the media item/-s and/or media field/-s become accessible. This optimizes the use of the available and visual touch sensitive display area by optimizing the size of each layout of media items and/or media fields in relation to physical, visual and touchable area of the display and desire of the user.

Yet another aspect of the inventive idea combines this PSLGUI with information and action-layering meaning that at least one media item and/or at least one associated media field is increased in size while, at the same time, at least one other media item and/or at least one media field associated with the other media item is decreased in size when changing to a new layout of a display. This enlarges at least one media item/field displaying more content and/or information and/or more actions on the media item/field become accessible, while, simultaneously, at least one other media item/field is decreased displaying less content and/or information and/or fewer actions on the other media item/field become accessible. This optimizes the use of available and visual touch sensitive display area by optimizing the size of each layout of media items/fields shown on the display in relation to physical, visual and touch sensitive area of the display, i.e. the optical screen, and the desire of the user.

The uniqueness of this innovation according to the invention lies in the combination of a learnable gesture (pinch-spread by at least two fingers) with a principle of information layering, in the context of media presentation enabling more or less information and/or interactive actions to be accessible for each media item. The invention maximizes/optimizes the size of the layout of the media items on the user interface in relation to the size of the available visible and touch sensitive area of the touch sensitive display. The inventive layout control is adapted to take up the available/usable and visual and touch sensitive display area, independently of the display using portrait or landscape orientation, by displaying an integer number of media items with or without shown media fields according to the invention. The inventive layout control is adapted to take up the available/usable width of the visual and touch sensitive display area, independently of the display using portrait or landscape orientation, by displaying an integer number of media items with or without shown media fields, according to the invention. The inventive layout control is adapted to take up the available/usable height of the visual and touch sensitive display area, independently of the display using portrait or landscape orientation, by displaying an integer number of media items with or without shown media fields according to the invention. This enables an optimization of the use of available and visual and touch sensitive display area of the mobile electronic device by maximizing the size of each layout of media items and/or associated media fields by displaying an integer number of media items/fields in relation to the physical touch sensitive and visual area of the display according to the invention. This enables a minimization of the non-usable touch sensitive area of the touch sensitive display by minimizing the touch sensitive area of the touch sensitive display where no media items/fields are displayed, i.e. present or shown, according to the invention. This minimizes the non-usable touch sensitive area of each layout of media items/fields on the touch sensitive display making a very efficient use of the visual and touchable touch sensitive area of the display according to the invention.

### BRIEF DESCRIPTION OF THE DRAWINGS

The features and advantages of the present invention will be more apparent from the following description of preferred aspects with reference to the accompanying drawings, in which

FIG. 1 schematically illustrates an electronic communication device in the form of a mobile phone, configured to be operated in accordance with the invention;

FIG. 2 schematically illustrates an electronic communication device in the form of a mobile phone, configured to be operated in accordance with the invention;

FIG. 3 schematically illustrates one lay out of a graphical user interface (GUI) on a touch sensitive display of the mobile phone of FIGS. 1 and 2 with media items whose sizes are defined by white areas similar to white lines;

FIGS. 4 to 6 show other GUI layouts that may be changed between for use as GUIs on the touch sensitive display in the mobile phone of FIGS. 1 to 3;

FIGS. 4A to 6A correspond to FIGS. 4 to 6 and show other GUI layouts that may be changed between for use as GUIs on the touch sensitive display in the mobile phone of FIGS. 1 to 3 but also show a grid in dotted lines associated with the physical touch resolution of the touch sensitive display for disclosing the relationship between sizes of media items and their media fields and the touch grid according to the invention;

FIGS. 7 to 9 illustrate yet other GUI layouts that may be changed between for use as GUIs on the touch sensitive display in the mobile phone of FIGS. 1 to 6A;

FIGS. 7A and 8A illustrate yet other GUI layouts that may be changed between for use as GUIs on the touch sensitive display in the mobile phone of FIGS. 1 to 8;

FIGS. 10 and 11 also illustrate further GUI layouts that may be changed between for use as GUIs on the touch sensitive display in the mobile phone of FIGS. 1 to 9 for the interactive change between different entities in the process of generating a GUI layout on the display of the mobile phone, by means of the invention.

FIG. 12 illustrates a flowchart of a method for controlling the GUIs of the touch display in the mobile phone according to the invention.

FIG. 13 illustrates a flowchart of a method for controlling the GUIs of the touch display in the mobile phone according to the invention.

FIG. 14 illustrates a flowchart of a method for controlling the GUIs of the touch display in the mobile phone according to the invention.

FIG. 15 illustrates a flowchart of a method for controlling the GUIs of the touch display in the mobile phone according to the invention.

FIG. 16 illustrates a flowchart of a method for controlling the GUIs of the touch display in the mobile phone according to the invention.

### DETAILED DESCRIPTION

Aspects of the present invention relate, in general, to a radio communication terminal, such as a mobile phone, including one or more marker input devices. Aspects of the present invention relate, in general, to the field of automatically launching different layouts of applications in mobile communication devices. However, for the sake of clarity and simplicity, most aspects outlined in this specification are related to mobile phones. However, it should be appreciated that the invention is as such equally applicable to electronic devices which do not include any radio communication capabilities.

In the following description reference is made to the accompanying drawings. In this regard entity, dimensional, positional and directional terminology, such as “top”, “bottom”, “front”, “back”, “first”, “second”, “overlaid”, “non-overlay”, “first/second/top/bottom layer”, “larger”, “smaller”, “finer”, “more coarse”, etc., is used with reference to the size, resolution, position and orientation of the objects and figures being described. Because components and objects/items of aspects of the present invention can be positioned in a number of different orientations and have a varying order of use and placing, be of different sizes and resolutions, the terminology is used for purposes of illustration and is in no way limiting. It is to be understood that other aspects may be utilized and structural or logical changes may be made without departing from the scope of the present protection. The following detailed description is not to be taken in a limiting sense, and the scope of the present invention is defined by the appended claims.

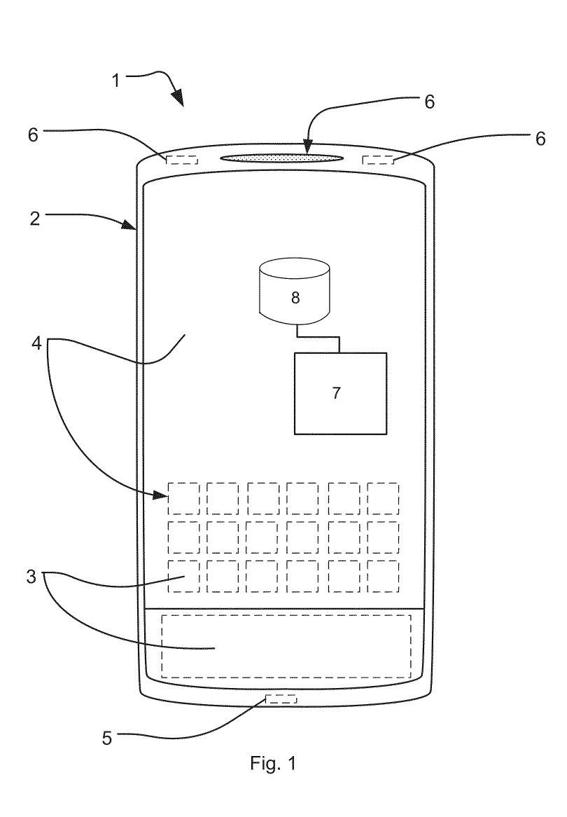

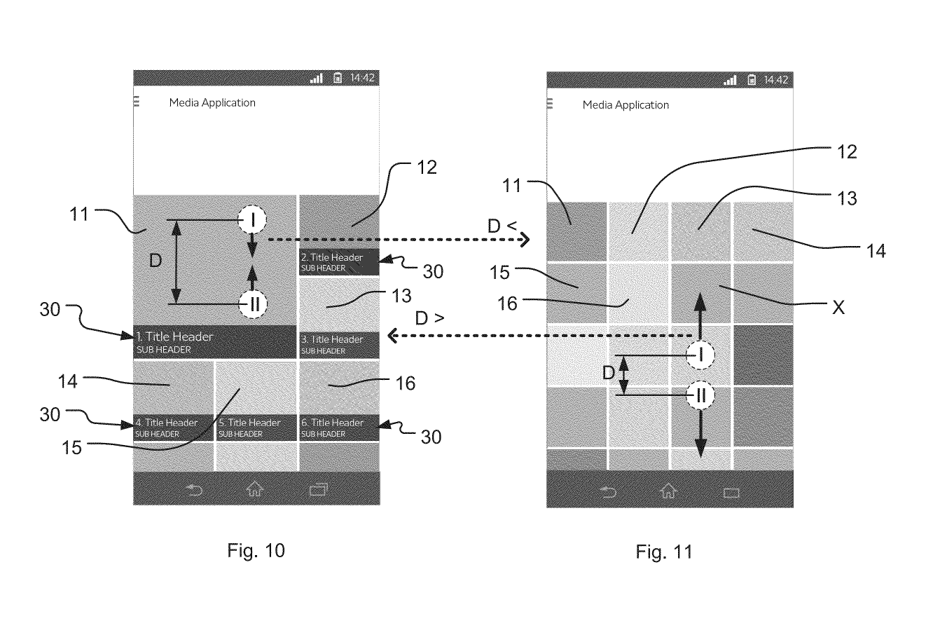

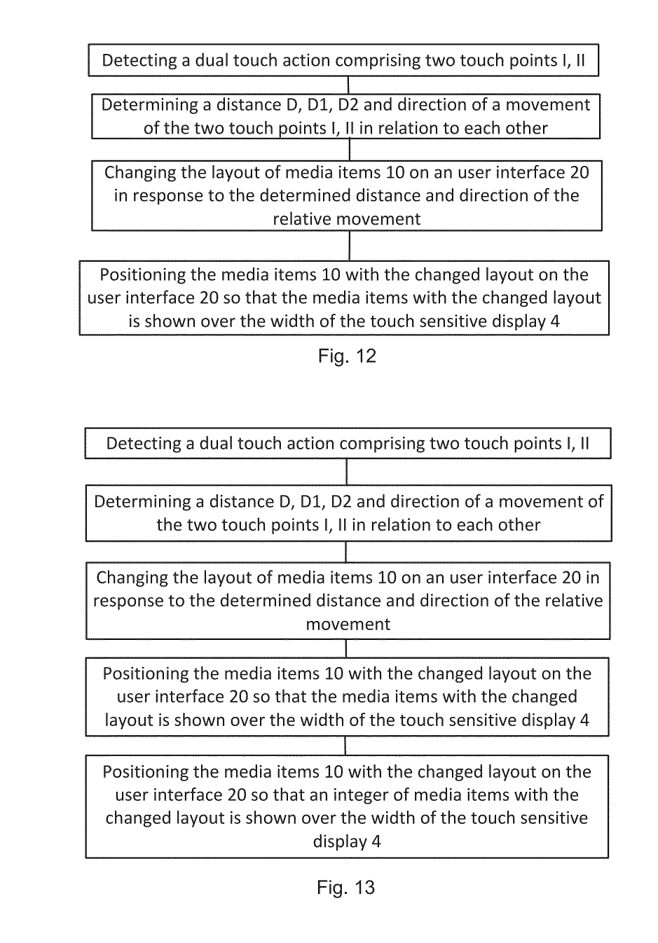

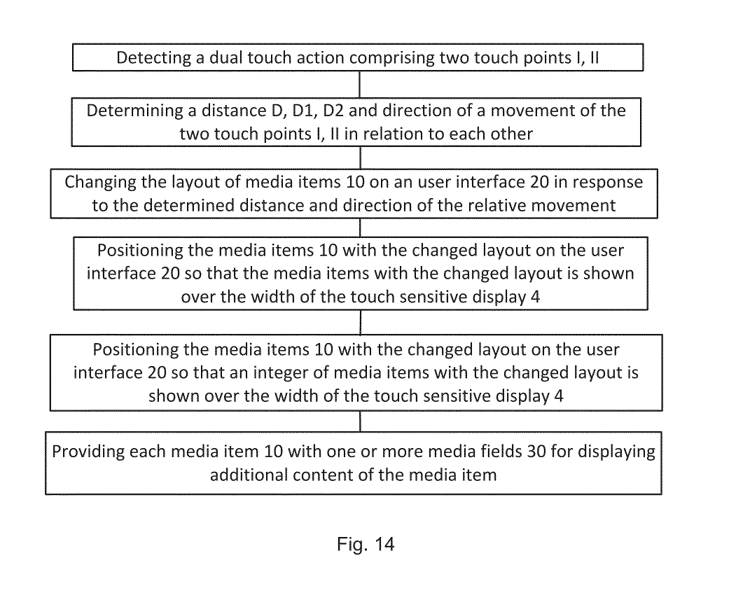

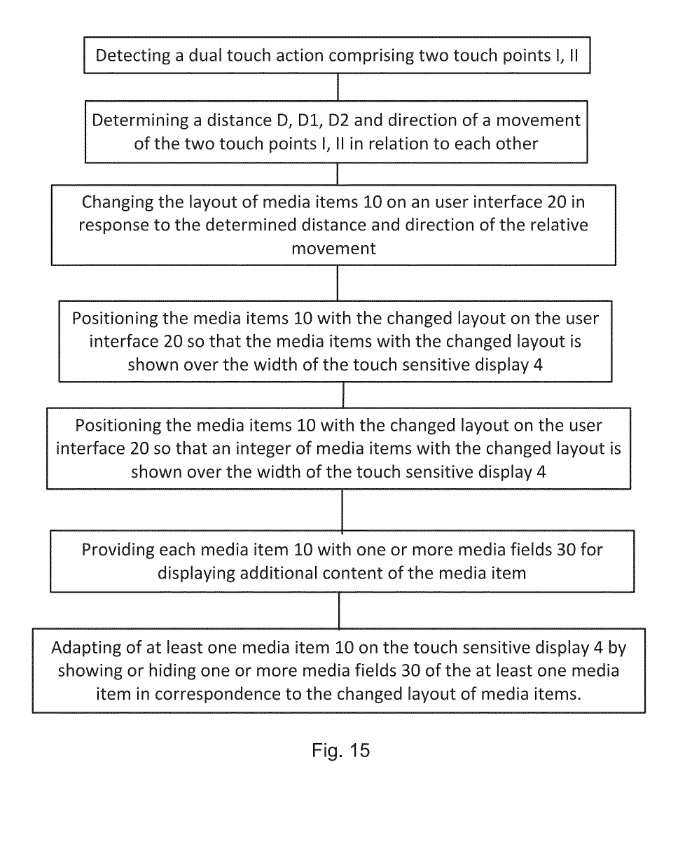

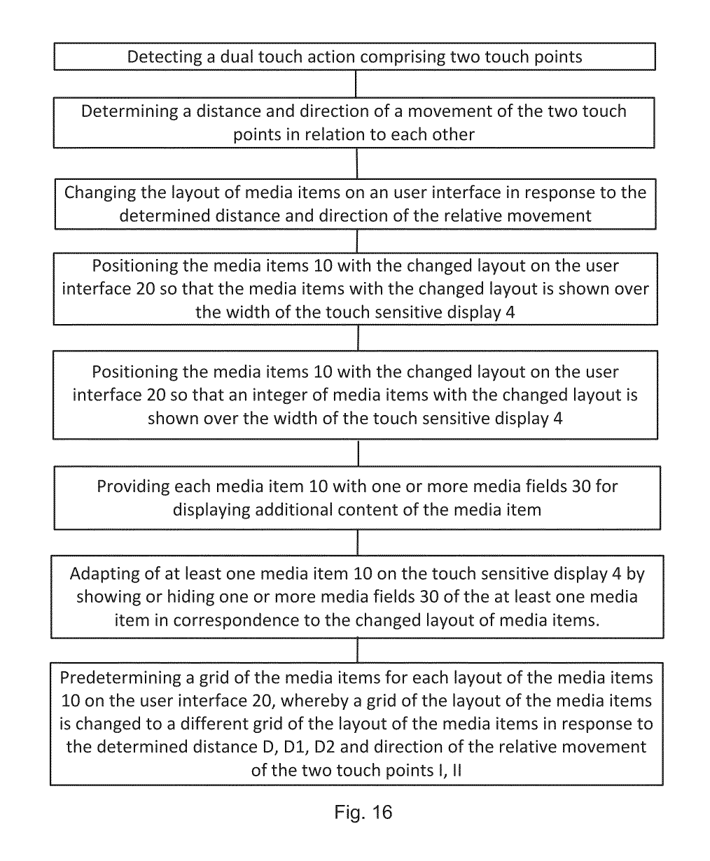

Exemplary embodiments will now be described with references made to the accompanying drawings. FIGS. 1 to 11 illustrates a mobile electronic device 1, i.e. at least its display. FIGS. 12 to 16 schematically illustrate a method according to the invention for controlling and adapting a graphical user interface of the mobile electronic device 1 to the likings of a user in regard of changeable lay outs of media items 10 on a touch sensitive display 4 of the mobile electronic device 1. Examples of devices 1 are mobile phones, smart phones, laptops, touch pads, media plates etc.

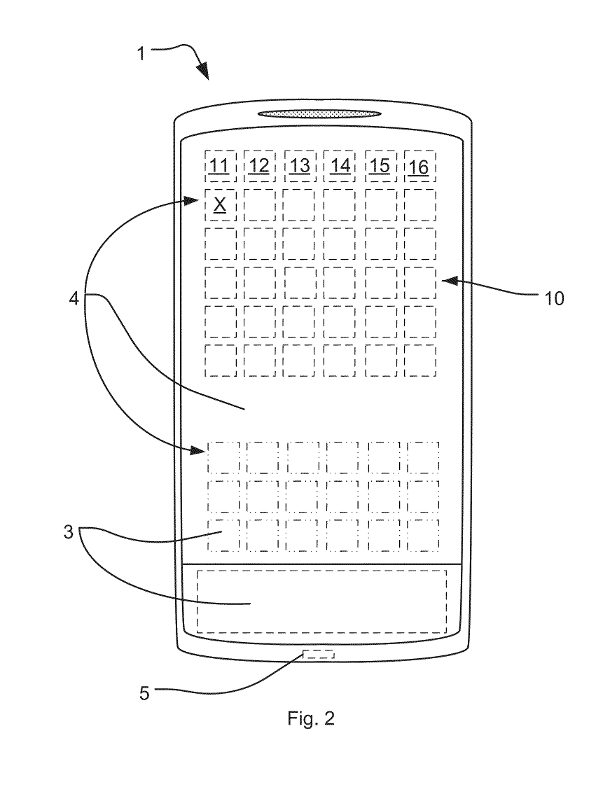

FIGS. 1 and 2 schematically illustrate the portable electronic device 1 in the form of a mobile phone. Details of the mobile phone 1 as such are of little importance to the invention, but for the sake of clarity it should be mentioned that the phone 1 comprises a support structure 2 including a chassis and a cover, directly or indirectly supporting the other components of the phone. Phone 1 is further devised with a user interface comprising a keypad 3 and/or the touch-sensitive display 4, as well as a microphone 5 and at least one speaker 6. Though not shown in FIGS. 1 and 2, phone 1 further comprises a signal transceiver, including an antenna and radio transmission and reception electronics, for communicative connection to base stations of communications networks, such as GSM or WCDMA networks; a power supply in the form of a battery, and a cable socket for connection to a mains outlet via a transformer. Phone 1 is also devised with a computer system, including a microprocessor with associated memory and software, configured to carry out the tasks of signal processing and data handling in the phone. All of these features are, as such, well known in the field of telecommunication devices but not all shown on the figures. The phone 1 comprises a processing unit 7 that may be constituted by any suitable Central Processing Unit, CPU, microcontroller, Digital Signal Processor, DSP, etc., capable of executing computer program code for operating phone 1. A software handler may be implemented utilizing the processing unit 7 for determination and switching between different input and/or user interface modes and/or lay outs of media items 10. The phone 1 further comprises a memory 8 that can be used for storing computer program code, data code in files representing e.g. images, games, music, and video, and other relevant or desired data etc. The memory 8 can be any combination of a Read and write Memory, RAM, and a Read Only Memory, ROM. The memory 8 may also comprise persistent storage, which, for example, can be any single one or combination of magnetic memory, optical memory, or solid state memory or even remotely mounted memory. The phone 1 also comprises other components required for its operation, such as input buttons at its support structure 2, circuit wiring and associated components, but these components are not explained further as this is common knowledge for a skilled person.

The control unit 7 represents the microprocessor of the computer system configured to control the processes carried out within the mobile phone 1. In order for a user to control and monitor the processes carried out under control of the control unit 7, all the above elements making up the phone 1 are operatively and communicatively connected to the control unit 7. In the present embodiment, the control unit 7 is also connected to the radio communication components for wireless communication, but these enabling components have no reference numerals as these components are known and any further details of them have no importance in regard of understanding the invention.

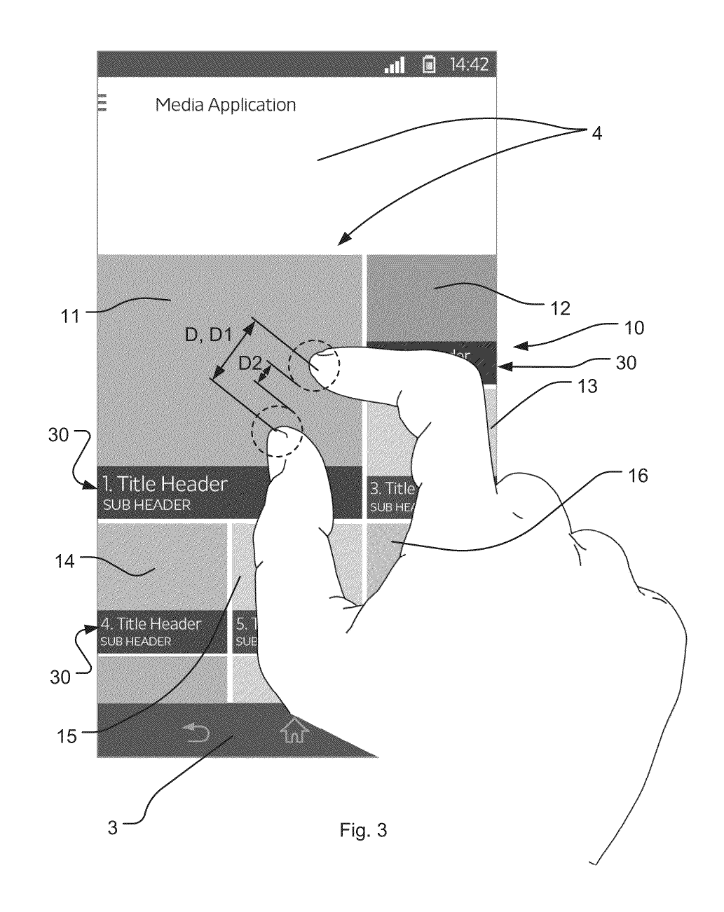

In accordance with the invention, at least one of the problems above is solved or at least reduced by combining the detection of a dual touch action comprising two touch points I, II with simultaneous determination of a command associated with a distance D, D1, D2 and direction of the dual touch action (see black filled arrows shown with unbroken lines of FIGS. 3-11) of in regard of a movement of the two touch points I, II in relation to each other when entered on the touch-sensitive display 4, as a trigger to execute a desired input action in the mobile phone 1. This desired input action comprises changing the layout of media items 10 on the user interface 20 of the mobile phone 1 in response to the determined distance and direction of the relative movement. This change of layout of media items 10, 11-16 also comprises adapting of media fields 30 corresponding to the media items on the touch sensitive display 4, such that the layout/design/appearance and content of each media field 30 corresponds to the layout of the media items. This change from one layout of media items 10, 11-16, X to another is shown on FIGS. 3-11 (symbolized by black arrows shown with dotted lines and non-filled arrow heads) in these figures for a better understand of switching between the layouts.

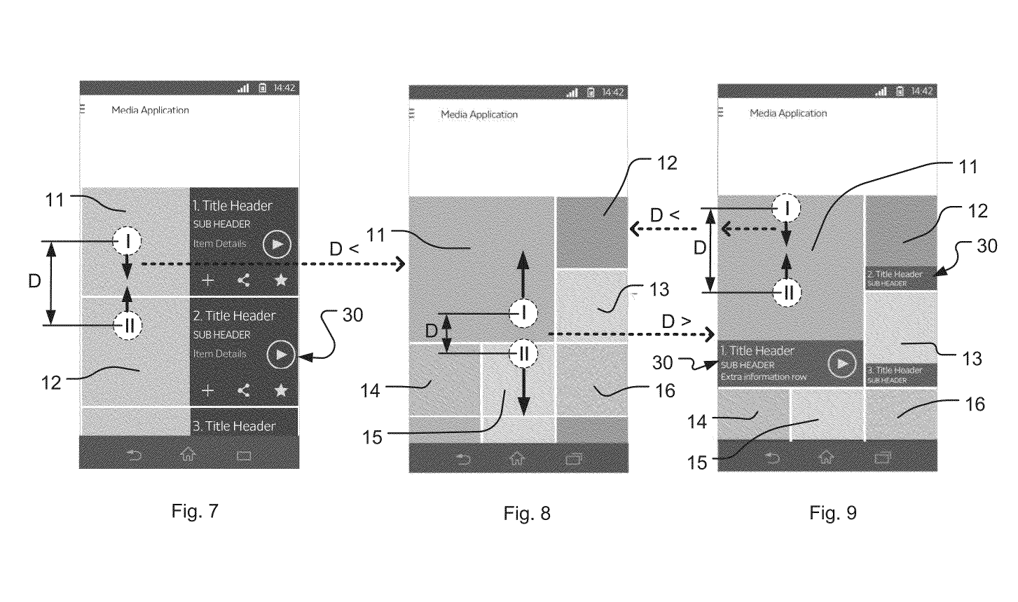

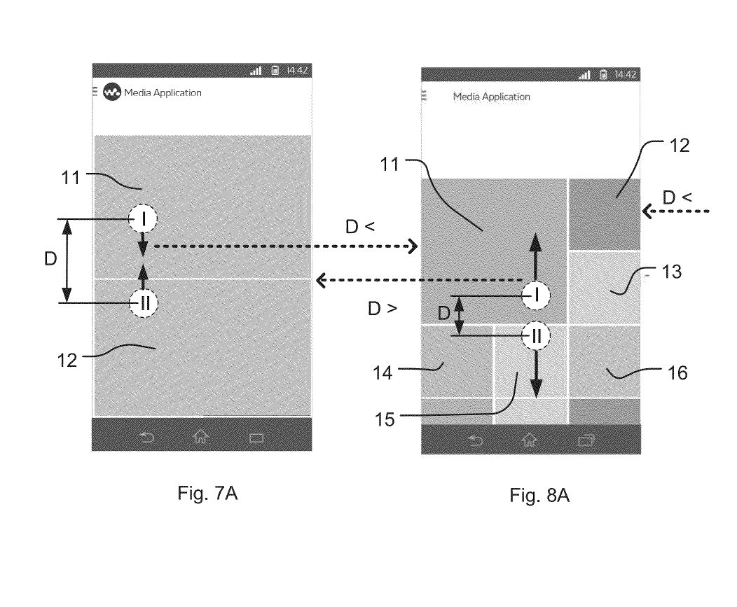

FIGS. 2-11 illustrate a scenario according to an aspect of the invention, where phone 1 is placed in action mode and/or in operational mode ready for use. The phone 1 may contain a Near Field Communication interface, e.g. Bluetooth™, but this will not be described in any greater detail. The aspects of FIGS. 2 to 11 relates to a scenario where the user of the phone 1 wants to handle at least one media item 10, 11-16, e.g. a media file, such as music, video or a picture or the like. A plurality of objects 11-16 (one item shown with X in FIG. 2 to visualize that more than six, i.e. 11-16, seven and eight media items 10 may be present on the display 4 depending on application running on the phone 1 and the wishes of its user), in this case media items in the form of pictures of e.g. music albums, are shown on the display 4. In the illustrated aspects there are at least one or more media items 10-16 being music albums shown. The displaying of these media items 10-16 may be activated responsive to the dual touch action, wherein displaying of the media items 10-16 stored in a memory 9 in a certain layout is set as a default action to be carried out when the type and size of the dual touch action is detected. Alternatively, a command has been entered by the user of phone 1, by means of an input key of keypad 3 or on touch-sensitive display 4, to display all media items 10-16 of memory 9, or all media items of a certain folder in memory 9, i.e. only certain media items, e.g. only media items 11-16 in FIG. 3 or only media items 11-14 in FIG. 6 or only media items 11 and 12 in FIG. 7. The media items 10 may be shown in the same sizes but also be shown in different sizes or be shown with at least one media item, such as media item 11 in FIGS. 3, 5, 5A, 8, 9, in a larger state than the remaining items 12-16.

In a state of the art mobile phone, there are a number of different actions that may be carried out when one or more media items are shown on display 4. Using a soft or touch key function, you may e.g. edit a picture, rename it, use it as background, send it and so on. In the present aspects, though, the simultaneous presentation of the media items 10 and detection of an established or predetermined dual touch action, renders a predetermined executable action such as a layout change to be ready to be carried out or in fact carried out, and preferably also presentation of a new layout on the touch display 4 indicating/showing the result of the action, namely a greater or lesser resolution of media items 10 on the display. By touching the first media item 11 or object (or a second object 12, a third object 13 or a fourth object 14, or a fifth object 15, or a sixth object 16, and so on), e.g. a music or video file, or a picture, on display 4, the dual touch action interface is triggered to execute the desired command based on that object after detecting the direction of the movement of the two touch points I, II in relation to each other, either a pinch or spread direction, i.e. to change the layout of the media items into a finer grid of media items (the pinching effect) or to a more coarse grid of media items (the spreading effect), e.g. to a greater or lesser number of music album icons or pictures on the display. The distance of the movement of the two touch points I, II in relation to each other determines the scale or size of the resolution, i.e. the degree of the fineness and coarseness of the layout of media items 10, 11-16, X changed or switched into or to be changed or switched into after the performance and execution of the command associated with the specific dual touch action gesture.

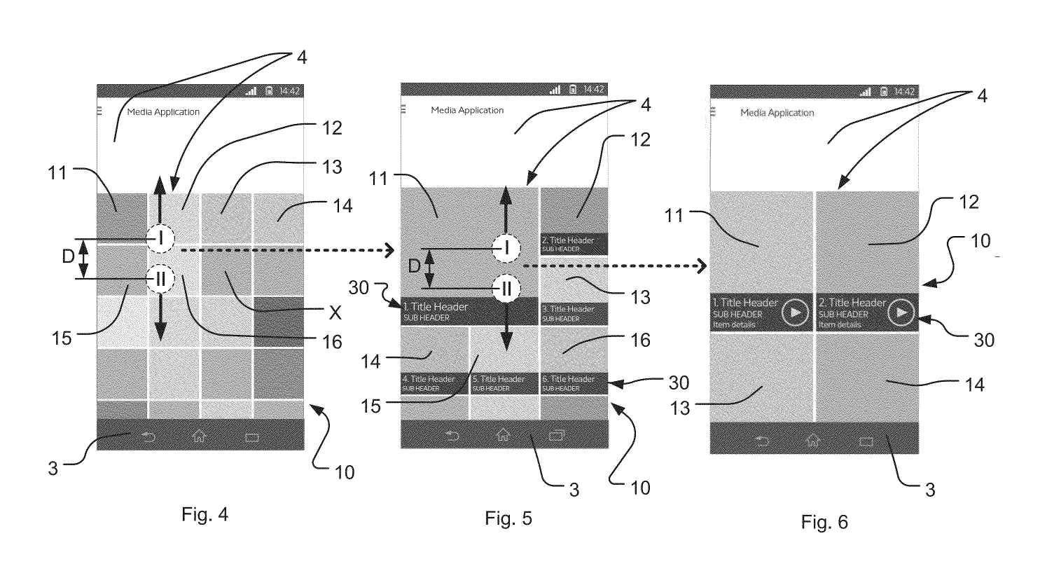

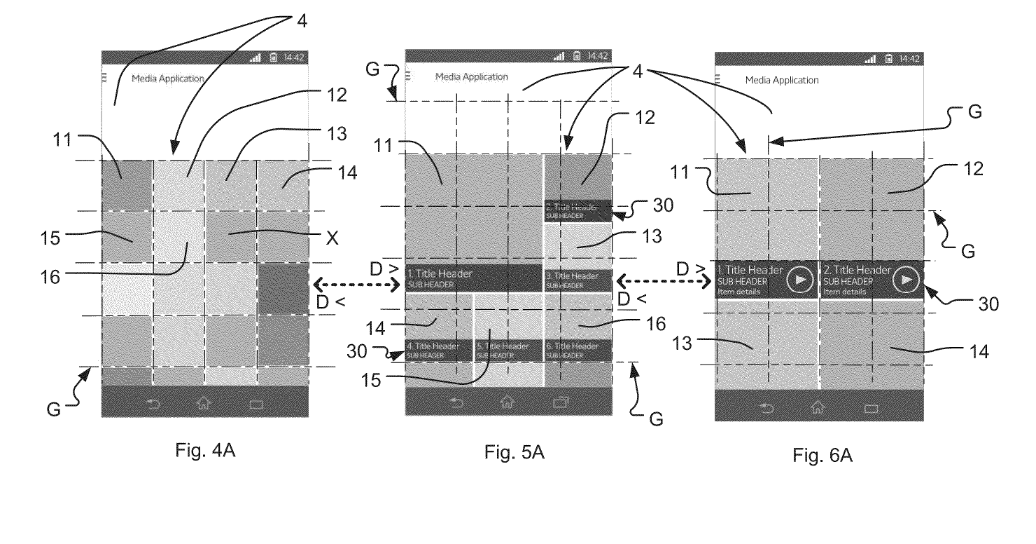

Specifically, the method according to the invention for controlling a layout of media items 10, 11-16, X on a user interface 20 for the mobile electronic device 1 comprising the touch sensitive display 4 having a specific touch resolution or touch grid G. This touch resolution/grid G may be about 9×9 mm per square times the number of squares for the whole touch sensitive area/grid of the display 4. This dimension of 9×9 mm for each touch square may be larger or smaller depending on the display technology used or the actual resolution demands for users or manufacturers or of the specific type or size of the portable electronic device. The method specifically comprises detecting a dual touch action comprising two touch points I, II. The method also comprises determining a distance D, D1, D2 (see FIGS. 3-5, and 7-11) and direction of a movement of the two touch points I, II in relation to each other (see direction of relative movement of touch points I and II symbolized by arrows shown with unbroken lines and filled arrow heads of FIGS. 4, 4A, 5, 5A, 6A, 7A, 8A and 7-11). The touch areas or points I and II are also symbolized as circular areas shown with dotted lines in FIGS. 3, 4, 5, 7-9, 7A, 8A, 10 and 11. The method also comprises changing the layout of the media items 10, 11-16, X on the user interface 20 in response to the determined distance D, D1, D2 and direction of the relative movement between the two touch points I, II in relation to each other. The method also comprises adapting of media fields 30 corresponding to the media items on the touch sensitive display 4, so that the layout/design/appearance and content of each media field corresponds to the desired or chosen layout of the media items.

The method provides that each layout of the media items 10, 11-16, X comprises a predetermined grid of the media items on the user interface 20, i.e. enabling that a current grid of the layout of the media items is changed to a different grid of the layout of the media items in response to the determined distance D, D1, D2 and direction of the relative movement of the two touch points I, II. This is done by performing a distinct snap-like switch from the current layout to a new layout in response to the determined distance D, D1, D2 and direction of the relative movement of the two touch points I, II. This snap-like switch creates an intuitive handling and effect of the pinch or spread gesture as it is immediately and directly recognizable in a very simple way.

Each change of layout of the media items 10, 11-16, X is performed by means of switch from the current layout to any new layout by means of the dual touch action being either the pinch gesture on the touch sensitive display 4 decreasing the distance D, D1, D2 between the two touch points I, II (see FIGS. 4, 5, 7, 8, 9, 7A, 8A, and 10 and 11 showing the increased distance of D, D1, D2 as general increase by symbol D>) or a spread gesture on the touch sensitive display 4 increasing the distance D, D1, D2 between the two touch points I, II (see FIGS. 4, 5, 7, 8, 9, 7A, 8A, and 10 and 11 showing the decreased distance of D, D1, D2 as general increase by symbol D<).

The pinch gesture changes to a finer grid of the media items 10, 11-16, X, enlarging the size of the associated and displayed media fields 30 for revealing more and more amount of content until each media field cannot be any larger, revealing a maximum content of at least one media field 30 if not all media fields shown are of the same size at the “lowest” or most enlarged level of media item layouts.

The spread gesture changes to a more coarse grid of the media items 10, 11-16, X, lessening the size of the associated media fields 30 for revealing less and less amount of content until at least one media field of at least one media items 10, 11-16, X is decreased in size, disappears or is totally hidden, if not all media items are of the same size. Then, in the top or most minimized level of media item layouts and if all media items 10, 11-16, X are of the same size, all the media fields 30 revealed in the former layout have disappeared, i.e. are totally hidden. Hence, at least one layout of the media items 10, 11-16, X may comprise a more coarse grid for a first media item 11 with or without visible media field(s) 30 and a finer grid for the remaining media items 12-16 with or without visible media field(s) 30 (see FIGS. 3, 5, 5A, 8, 8A, 9, 10). This means that the number of changes of layout of the media items 10. 11-16, X is controlled in response to the determined distance D, D1, D2 and direction of the relative movement of the two touch points I, II in one and the same dual touch action.

Therefore, the method may optimize the appearance and content of each visible media field 30 in relation to the size of each media item 10, 11-16, X. The method may also optimize the displayed layout/design/appearance and content of each media field in relation to the touch resolution G of the touch sensitive display 4 and may optimize the displayed layout, design, or appearance and content of each media item in relation to the touch resolution G of the touch sensitive display. Furthermore, if desired, the displayed media field 30 may at least partly overlay any media item 10, 11-16, X. However, if at least one media item resembles any artwork, the visible media field 30 may not overlay this media item, or, if desired, the shown media field 30 may not overlay any media item.

The effect of the invention as explained above is that it provides all types of users, situations and devices with an easily adaptable dynamic layout of media items 10, 11-16, X on a touch sensitive display 4, whereby the same and static layouts in an application as in prior art applications is eliminated. This is due to that different users prefer different layout styles on their portable electronic devices 1. Some users prefer a display view with many small interactive items while others want few large items that are easy to tap or see. Other users require a lot of information when presented with a previously unknown item 10, 11-16, X in order to take action on it by tapping it, while others consider more text as messy and “in the way”. Some users never use secondary actions while for some they are the key to the whole experience of a more suitable layout satisfying functional and practical needs, but yet optical/graphical preference. Some users consume a lot of new content every day, and others are more selective. This inventive way of “picking”/changing into preferable layouts on displays of portable devices 1 fulfills the needs of a broader span of “mass consumers”, but also more “picky” ones than a standard prior art grid layout does. There is also a need to adapt the layout to a current situation, e.g. when being on the move, for example running or walking, a layout with large touch targets/items/fields 10, 30 would be preferred. On the other hand—when the user has a lot of time on their hands they might be interested in reading more about each item 10, 11-16, X and/or use more functions for each item. The effect of the invention is also that the use of the touch sensitive and visual area of the display 4 is more efficient and the display more easily viewed as the width and/or the height of the display is “filled up” by showing an integer number of media items/fields for each layout. Hence, the user does not have to “pan” or scroll to the side or vertically on the display to view partially or halfway shown information/content. This method improves the use of touch sensitive displays 4 and makes the use more efficient compared to touch sensitive areas on displays on for example a media plate or laptop, which media plate or laptop each has larger displays compared to smartphones, wherefore the displays of the media plate or laptop has non-used touch sensitive areas or areas that is not occupied by or do not show any media items/fields, defined as “dead” or “free” space, as the available touch sensitive area of each plat or laptop is excessively/unnecessary large compared to more compact smartphone display areas in need of a more efficient use thereof.

By combining a touch-sensitive display function with detection of a dual touch action on a portable communication device, the ease of use of the portable communication device and its different menus of its graphical user interface is enhanced. Making e.g. a plurality of selectable commands by a pinch gesture or a spread gesture on the touch sensitive display decreases the invisibility of interaction with the graphical user interface and the underlying software, e.g. applications and any media files/data, so that the user will sure of what actually happens in the interaction with the graphical user interface as it is more clearly visible. Furthermore, there will be fewer accidental interactions when the mobile phone is positioned in for example a pocket or bag, since the user needs to use a dual touch action on an object on the display/screen to trigger a desired action. This increases the control over the near field communication process. Furthermore, the present invention provides the ease of use sought for by the market, in a time where different types of data, software, and advanced graphical interfaces, e.g. for playing music or video or interacting with different social media, and of course for the wireless communication with other mobile phones or the like wireless devices, not only provide extended capabilities for a user but also requires a higher degree of knowledge from the users.

FIGS. 12 to 16 illustrate flowcharts of the method for controlling the input mode of the touch display/screen 4 for the phone 1. The phone comprises at least one input detection system, e.g. a capacitive touch detection system (not shown) indicating touching on the touch display 4. This capacitive touch detection system indicating touching on the touch display 4 is operatively connected to the processing unit 7 of the phone 1 for enabling the control of the GUI 20 according to the invention.

The pinch and spread gestures according to the invention achieves an information layering in combination with a “surfacing” or hiding of secondary actions or more detailed information in the distinct snap-like switch from a current layout state to a new layout state of media items/fields on mobile devices 1. Each layout state can be seen as a separate display level with its own unique purpose. How many laid out states or display levels that are used or passed from one layout to another depends on and are represented by the size of the gesture, i.e. the distance D, D1, D2 between the two touch points I, II in relation to each other. The distance may be measured in relation to the centres of the touch points or areas I or II (see D and D1 of FIG. 3) or in relation to the outer circumference of the touch points or areas I or II (see D2 of FIG. 3). As an example, a pinch gesture may be used to show less, hide or re-position titles on music albums and a spread gesture increasing the distance D, D1, D2 between points I, II can show more, e.g. titles, and if spread more, i.e. if D, D1 or D2 gets larger (D>), more information, e.g. more rows of information or larger areas and number of interactive icons, such as play buttons, stars/cookies/favourites, is shown. The pinch gesture as used for showing less, hiding or re-positioning media items 10 and their media fields 30 decreases the distance D, D1, D2 between points I, II, and if pinched more, i.e. if D, D1 or D2 gets smaller (D<), less information, e.g. less rows of information or smaller areas and number of interactive icons, such as play buttons, stars/cookies/favourites, is shown until when fully pinched out, no information is shown except for pictures.

Each change of layout of media items 10, 11-16, X is performed by means of the distinct spring-/leap-/snap-like changeover/transition from a current layout to a new layout in response to the determined distance D, D1, D2 and direction of the relative movement of the two touch points I, II.

The number of interactive media fields is easy to rearrange/adapt to the corresponding media items on the touch sensitive display, wherein the number of media items corresponds to the determined distance and direction of the relative movement. The number of displayed media items and/or media fields is/are always an integer shown over the width and/or height of the display 4. At least one media item may also be detected as a center point or area corresponding to the two touch points, such that the new layout that is changed centers the at least one media item. As explained earlier, the layout of at least one media item on the GUI may be changed in response to the determined distance over at least two levels of layers or layouts instead of only one layout or layout level at a time depending on the actual pinch/spread size.

Information and media items and media fields (contents thereof) may not only be limited to the sharing of music, video or picture files. Other type of information may also be shared such as streaming data, links or references to data, contact information, message data, text and document data (e.g. .txt, .pdf, .doc, .ppt, .exe, etc.), and metadata. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein in this description and in the appended claims, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein. The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A method of controlling a layout of media items on a user interface for a mobile electronic device comprising a touch sensitive display, the method comprising:
detecting a dual touch action comprising two touch points,
determining a distance and direction of a movement of the two touch points in relation to each other,
changing the layout of the media items on the user interface in response to the determined distance and direction of the relative movement, and
positioning the media items with the changed layout on the user interface so that the media items with the changed layout is shown over the width of the touch sensitive display.

2. A method according to claim 1, comprising positioning the media items with the changed layout on the user interface so that an integer of media items with the changed layout is shown over the width of the touch sensitive display.

3. A method according claim 1, wherein each media item comprises one or more media fields for displaying additional content of the media item.

4. A method according to claim 1, comprising adapting of at least one media item on the touch sensitive display by showing or hiding one or more media fields of the at least one media item in correspondence to the changed layout of media items.

5. A method according to claim 1, comprising predetermining a grid of the media items for each layout of the media items on the user interface, whereby a grid of the layout of the media items is changed to a different grid of the layout of the media items in response to the determined distance and direction of the relative movement of the two touch points.

6. A method according to claim 1, wherein each change of layout of the media items is performed by means of a distinct snap-like switch from the layout to the changed layout in response to the determined distance and direction of the relative movement of the two touch points.

7. A method according to claim 1, wherein each change of layout of the media items is performed by means of switch from the layout to the changed layout by means of the dual touch action being either a pinch gesture on the touch sensitive display decreasing the distance between the two touch points or a spread gesture on the touch sensitive display increasing the distance between the two touch points, whereby a pinch changes to a finer grid of media items and a spread changes to a more coarse grid of media items.

8. A method according to claim 5, wherein at least one of the grids comprises a coarse grid for a first media item and a fine grid for the remaining media items.

9. A method according to claim 1, wherein the number of changes of layout of the media items is controlled in response to the determined distance and direction of the relative movement of the two touch points in one and the same dual touch action.

10. A method according to claim 3, comprising optimizing the layout and content of each media field in relation to the size of each media item.

11. A method according to claim 3, comprising optimizing the displayed layout and content of each media field in relation to a touch resolution of the touch sensitive display.

12. A method according to claim 1, comprising optimizing the displayed layout and content of each media item in relation to a touch resolution of the touch sensitive display.

13. A method according to claim 3, wherein the amount of displayed content of the media field increases when the distance between the two touch points increases in relation to each other and the amount of displayed content of the media field decreases when the distance between the two touch points decreases in relation to each other.

14. A method according to claim 13, wherein the displayed content of at least one media field comprises meta data and/or user selectable interactive action items, such as play or menu buttons or the like.

15. A method according to claim 3, wherein at least one media field at least partly overlays at least one media item.

16. A method according to claim 3, wherein at least one media field (30) does not overlay any media item.

17. A method according to claim 1, comprising increasing the size of at least one media item and decreasing the size of at least one other media item, in the same grid of layout of media items, when changing the layout of media items.

18. A method according to claim 3, comprising increasing the size of at least one media item and the size of at least one media field and decreasing the size of at least one other media item and the size of at least one other media field, in the same grid of layout of media items, when changing the layout of media items.

19. A method according to claim 3, comprising increasing the size of at least one media item or the size of at least one media field and decreasing the size of at least one other media item or the size of at least one other media field, in the same grid of layout of media items, when changing the layout of media items.

20. A method according to claim 1, comprising positioning the media items with the changed layout on the user interface so that an integer of the media items with the changed layout is shown over the height of the touch sensitive display.

21. A mobile electronic communication device using the method according to claim 1 for controlling its user interface on a touch sensitive display.
